(19) United States
(12) Patent Application Publication
(10) Pub. No.: US 2004/0240525 A1
(43) Pub. Date: Dec. 2, 2004

(54) Wireless communications methods and apparatus using licensed-use system protocols with unlicensed-use access points

(76) Inventors: Peter D. Karabinis, Cary, NC (US); Rajendra Singh, Alexandria, VA (US)

Correspondence Address: MYERS BIGEL SIBLEY & SAJOVEC, PO BOX 37428, RALEIGH, NC, 27627, US

(21) Appl. No.: 10/447,461

(22) Filed: May 29, 2003

(51) Int. Cl. H04B 1/713

(52) U.S. Cl. 375/132

(57) ABSTRACT

Communications of a wireless terminal with an unlicensed-use access point are controlled using a control channel of a licensed-use wireless communications system. For example, communications of a wireless terminal with an unlicensed-use access point may be controlled using a Control Channel (CCH) of a GSM wireless communications system. The terminal may communicate with the unlicensed-use system using substantially the same protocol supported by the licensed-use wireless communications system.

### BACKGROUND OF THE INVENTION

The present invention relates to wireless communications, and more particular, to communications with licensed-use and unlicensed-use communications systems.

Wireless communications are increasingly being used for applications other than voice telephony. Conventional “licensed-use” systems, i.e., systems that use licensed frequency bands in defined regions, such as GSM and the emerging “3G” standards (CDMA-2000, W-CDMA), also include capabilities for data communications for such applications as wireless internet, e-mail, and multimedia. “Unlicensed-use” networks, such as Wi-Fi, Bluetooth, and the like, may also provide voice and data communications services. These networks typically use unlicensed frequency bands, such as the International Scientific and Medical (ISM) band (2.4 GHz to 2.5 GHz), to provide relatively short-range communications with devices that may be constrained in terms of output power, and/or radiated waveform characteristics.

In order to maximize the probability that interference resulting from unlicensed transmissions will be unbiased and uniformly distributed (at least on the average), spread-spectrum waveforms are typically required of devices that are designed to intentionally radiate over an unlicensed band. The output radiated power of a device that is configured to intentionally radiate over an unlicensed band may be as high as one (1) Watt, provided that pseudorandom and uniformly-distributed frequency hopping is employed, and the hopping rate exceeds, or equals, a lower bound and/or direct sequence spreading is used. Such unlicensed bands are commonly used for Local Area Networks (LANs) and Personal Area Networks (PANs). Such LANs and/or PANs are expected to proliferate and find wide commercial use.

### SUMMARY OF THE INVENTION

In some embodiments of the present invention, communications of a wireless terminal with an unlicensed-use access point are established and/or controlled using a protocol exchange over a licensed-use wireless communications system. For example, communications of a wireless terminal with an unlicensed-use access point may be established and/or controlled via a protocol exchange over a Control Channel (CCH) and/or a Random Access Channel (RACH) in a GSM or CDMA wireless communications system. The terminal may communicate with the unlicensed-use system using substantially the same protocol that it uses to communicate with the licensed-use communications system.

In some embodiments, a presence signal transmitted by the unlicensed-use access point is detected by the wireless terminal, and the communications of the wireless terminal with the unlicensed-use access point are established and/or controlled responsive to detection of the presence signal by the wireless terminal. In further embodiments, the wireless terminal transmits an access request message, and communications of the wireless terminal with the unlicensed-use access point are established and/or controlled using a control channel responsive to a determination of communication quality based on reception of the access request at the unlicensed-use access point. The invention may be embodied as methods and apparatus.

### BRIEF DESCRIPTION OF THE DRAWINGS

FIG. 1 illustrates an exemplary environment in which some embodiments of the present invention may be practiced.

FIG. 2 illustrates wireless communications of a terminal with licensed and unlicensed systems according to some embodiments of the present invention.

FIGS. 3-5 are flowcharts illustrating exemplary operations according to various embodiments of the present invention.

FIG. 6 illustrates a wireless terminal apparatus according to some embodiments of the invention.

### DETAILED DESCRIPTION

The present invention now will be described more fully hereinafter with reference to the accompanying drawings, in which typical embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As used herein, “wireless communications system” refers to terrestrial and/or satellite-based wireless communications systems that may or may not employ a cellular structure, including, but not limited to, PCS and other wireless systems. “Licensed-use” systems include systems that use one or more frequencies in an exclusive manner as granted by governmental or quasi-governmental entities. Examples of such systems include, but are not limited to, wireless networks operated by cellular providers that operate under government-granted licenses to exclusively use particular frequencies in a particular manner in defined areas. “Unlicensed-use” systems include systems that use one or more frequencies in a non-exclusive (or “freely-licensed”) manner, including, but not limited to, systems, such as WiFi and Bluetooth systems, that use the ISM band and/or other so-called “unlicensed” frequencies. It will be appreciated that unlicensed-use systems may use frequencies that may be subject to an exclusive license for other uses (e.g., subject to certain power, signal type or geographical constraints). Similarly, licensed-use systems may use frequencies that may also be used for other, unlicensed uses.

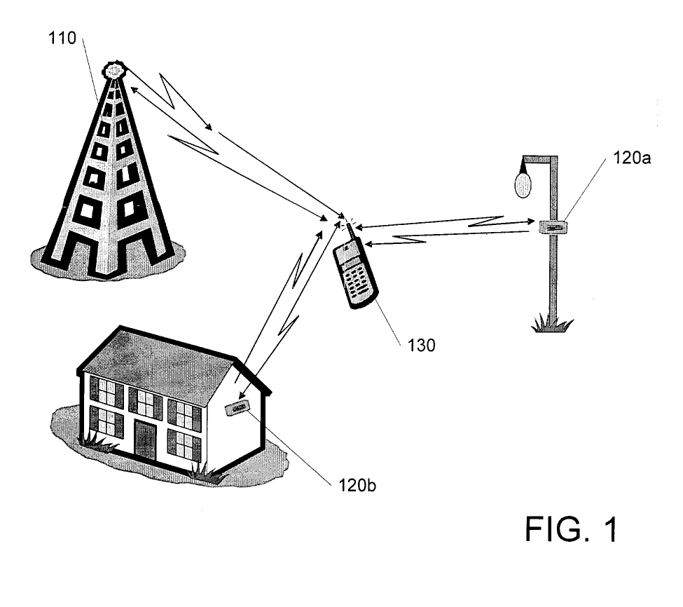

FIG. 1 illustrates an exemplary environment in which some embodiments of the present invention may be used. A terminal, here a mobile terminal 130, is operative to communicate with a base station 110 of a licensed frequency wireless communications system. The terminal 130 is also operative to communicate with access points 120a, 120b using one or more unlicensed-use frequencies. As described herein, the terminal 130 may communicate with the unlicensed-use access points 120a, 120b under control of the licensed-use wireless communications system, e.g., via control channel(s) established between the terminal and the base station 110. The communications between the terminal 130 and the unlicensed-use access points 120a, 120b may use substantially the same protocol used by the licensed-use wireless communications system, but radiated over the unlicensed-use frequencies. In this manner, transceiver components of the terminal 130, such as intermediate-frequency (IF) and baseband components, including software and firmware, may be commonly used for communications with the different systems.

The present invention arises from a realization that an established licensed-use wireless communications protocol, such as that used with GSM and/or CDMA terrestrial cellular/PCS systems, may be used, subject to relatively small modifications or, perhaps, no modifications at all, over unlicensed-use frequencies, provided that the regulatory requirements relevant to the unlicensed-use frequencies, for example, the use of spread-spectrum waveforms, are satisfied. The GSM protocol, for example, has already been specified to accommodate frequency hopping to achieve spread-spectrum modulation of TDMA carriers. Thus, protocol elements of a GSM air interface standard may be used substantially as is to provide short-range communications over at least some of the unlicensed-use frequencies. A potential benefit of being able to use an existing mass-market protocol for relatively short-range communications over unlicensed-use frequencies lies in having that protocol, in particular, a transceiver chip-set associated with that protocol, already inside of a terminal device, such as a cellular/PCS terminal. When such a terminal device comes near an unlicensed-use access point, the terminal device may register with the access point and begin communications within the unlicensed-use frequency band, instead of consuming the resources (e.g., frequencies) of the licensed-use wireless communications system.

Use of licensed-use and unlicensed-use communications systems may take many forms within the scope of the present invention. For example, in some embodiments of the present invention, a terminal and/or a system may be configured to preferentially use an unlicensed-use wireless communications system for certain types of services. For example, a terminal could be configured to preferentially use an unlicensed-use system for data communications while limiting use of a licensed-use system for such services. Thus, for example, the unlicensed use system could be used for bandwidth-intensive data communications applications, such as wireless internet, multimedia, and the like, while limiting use of the licensed-use system to voice communications and/or simple text messaging. A system may also be configured such that a terminal will preferentially use the unlicensed-use system for data communications, with provision of such services by the licensed-use system limited to circumstances in which the unlicensed-use system is unavailable to the terminal (e.g., when the terminal is in an area not covered by the unlicensed-use system and/or when a proximate access point of the unlicensed-use system is dysfunctional or overloaded). In further embodiments, a terminal may interleave communications between an unlicensed-use system and a licensed-use system to achieve improved link performance through diversity. For example, transmissions from a licensed-use system and an unlicensed-use system to a terminal and/or vice versa may be interleaved on a frame-by-frame or other basis to provide a transmit and/or receive diversity that can improve reception at the terminal and/or at the system.

According to some embodiments of the present invention, one approach to enabling communications of a terminal with an unlicensed-use access point is to have the terminal synchronize and monitor a control channel of a licensed-use wireless communications system while attempting to detect “proximity” to an unlicensed-use access point. Upon proximity detection, the terminal may inform the licensed-use wireless communications system, e.g., a cellular/PCS base station, that the terminal is in contact with a particular unlicensed-use access point.

For example, each unlicensed-use access point may radiate a “presence” signal. The terminal may detect the presence signal and thus know that it is proximate to an unlicensed-use access point. The presence signal may relay to the terminal the coordinates and/or other identifying information associated with the unlicensed-use access point. The terminal may continue to detect proximity to the unlicensed-use access point, e.g., periodically, and/or during intervals when the terminal is not monitoring the licensed-use wireless communications system. If the terminal decides that proximity to the unlicensed-use access point is lost and/or more favorable proximity is attained with respect to another unlicensed-use access point, the terminal may relay to the licensed-use wireless communications system this information. Thus, during intervals of time when the terminal is proximate to an unlicensed-use access point, the terminal may be commanded via a control channel of the licensed-use wireless communications system and/or via the unlicensed-use access point, to receive and/or transmit information via the unlicensed-use access point, via frequencies associated with the unlicensed-use access point, and not via the frequencies used by the licensed-use wireless communications system to establish communications.

The “presence” signal radiated by an unlicensed-use access point may be a direct sequence spread-spectrum waveform and/or a frequency-hopped carrier. If the presence signal is a frequency-hopped carrier, its frequency hop pattern may depend on Time-of-Day (ToD) and/or the physical coordinates of the access point. Thus, a terminal that is monitoring a control channel of a licensed-use wireless communications system may acquire accurate ToD from the control channel of the licensed-use wireless communications system and may thus tune its receiver accordingly to detect proximity to an unlicensed-use access point. Alternatively, and/or in addition to deriving ToD from control channel processing, the terminal may be equipped with GPS signal processing, and thus may be able to derive ToD information from processing of GPS signals. Even in the absence of any ToD information, a terminal may tune its receiver at a predetermined or randomly selected unlicensed-use system carrier frequency center, and wait there (per its permitted scheduling) until a “hit” of the presence carrier occurs. Each hop of the presence carrier may be configured to reveal the next hop location thus allowing a terminal that has detected one presence carrier hop to track and detect the rest. The hopping patterns of different presence carriers associated with geographically-proximate access points (that may be associated with the same unlicensed band) may be configured to be substantially orthogonal to prevent or minimize interference.

Another way to establish proximity to an unlicensed-use access point may be for a terminal to transmit information over an unlicensed-use system carrier frequency at, or near, the time when the terminal is being paged or is initiating a call. For example, the terminal may transmit a Random Access Channel (RACH) message over an unlicensed-use carrier frequency. An unlicensed-use access point that receives a terminal's transmission (RACH signal) may determine, from the received signal, whether or not the unlicensed-use access point is able to serve the terminal, and assign a reliability measure (a level of confidence) to such service. The unlicensed-use access point may then send a message to the system indicating a level of confidence regarding servicing the terminal.

The system may decide to instruct the unlicensed-use access point having the highest acceptable level of confidence to start servicing the terminal. In so instructing an unlicensed-use access point, the system may also transmit a “seed” to the terminal and to the unlicensed-use access point, the seed to be used by the terminal and the unlicensed-use access point in establishing, for example, a pseudo-random hopping pattern (or any other multiple access discriminator) to use in exchanging information. The seed may be sent to the terminal by the system via, for example, a control channel. If the terminal message (the RACH) is not heard by any unlicensed-use access point, or the system decides against allowing an unlicensed-use access point to serve the terminal, the terminal may not receive a response to its message transmission. Thus, the terminal waiting interval for such a response may expire, at which time the terminal may resend the message (the RACH) over the licensed-use wireless communications system frequencies.

The channels that may be allocated for communications between a terminal and an unlicensed-use access point may be based, for example, on Code Division Multiple Access (CDMA) and/or Time Division Multiple Access (TDMA) waveforms and may utilize either direct-sequence spreading and/or frequency hopping. When frequency hopping is employed in establishing unlicensed-use communications, the hopping may be, or may not be, orthogonal between two or more users that may be active over the same unlicensed-use access point. When direct sequence spreading is employed, an access point may, or may not, use orthogonal codes between two or more users that may be active over the unlicensed-use access point. However, using orthogonal codes on both the forward and return links may improve performance and increase access point capacity.

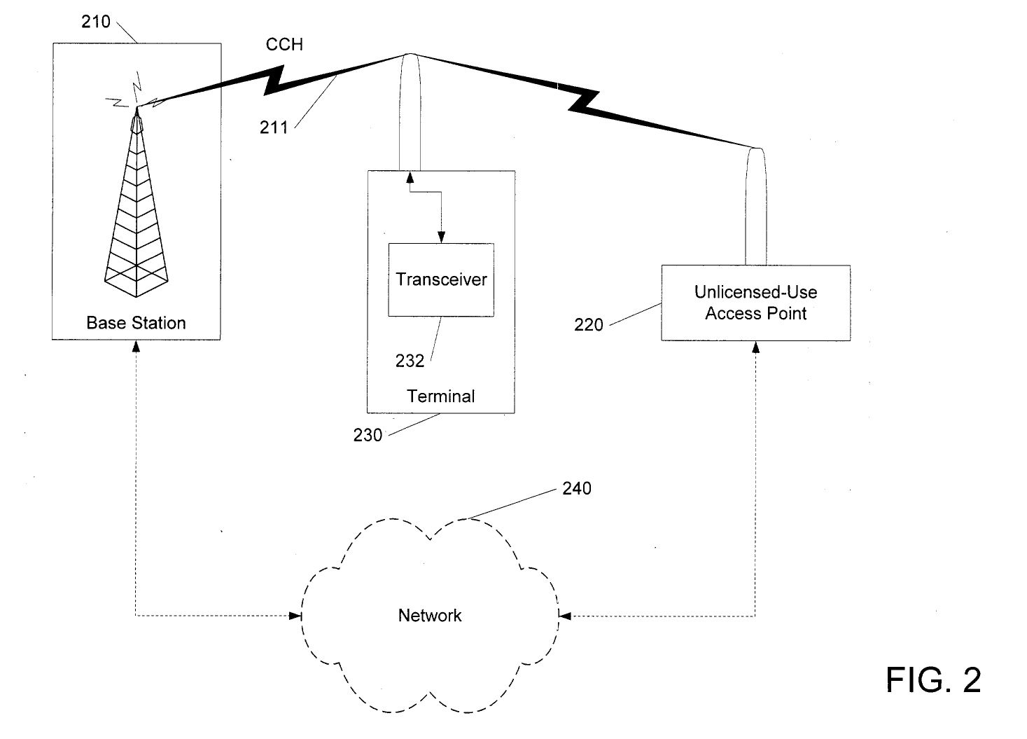

In the present application, FIGS. 2-6 are diagrams illustrating exemplary apparatus and operations according to embodiments of the present invention. It will be understood that operations depicted in the diagrams, and combinations thereof, may be implemented using one or more electronic circuits, for example, in a communications circuit of a cellular base station, unlicensed-use access point, and/or wireless terminal. It will also be appreciated that, in general, operations depicted in the diagrams, and combinations thereof, may be implemented in one or more electronic circuits, such as in one or more discrete electronic components, one or more integrated circuits (ICs), one or more application specific integrated circuits (ASICs), and application specific circuit modules, as well as by computer program instructions which may be executed by a computer or other data processing apparatus, such as a microprocessor or digital signal processor (DSP), to produce a machine such that the instructions which execute on the computer or other programmable data processing apparatus create electronic circuits or other means that implement the specified operations. The computer program instructions may also be executed on one or more computers or other data processing apparatus to cause a series of actions to be performed by the computer(s) or other programmable apparatus to produce a computer implemented process that includes the specified operations.

The computer program instructions may also be embodied in the form of a computer program product in a computer-readable storage medium, i.e., as computer-readable program code embodied in the medium for use by or in connection with an instruction execution system. The computer-readable storage medium may include, but is not limited to, electronic, magnetic, optical and other storage media, such as a magnetic or optical disk or an integrated circuit memory device. For example, the computer program instructions may be embodied in memory included in a device. Accordingly, blocks of the diagrams of FIGS. 2-6 support electronic circuits and other apparatus that perform the specified operations, acts for performing the specified operations, and computer program products configured to perform the specified operations.

FIG. 2 illustrates exemplary embodiments of the invention. A base station 210 of a licensed-use wireless communications system may be configured to communicate with a wireless terminal 230 over a Control Channel (CCH) 211. For example, in a GSM embodiment, the CCH 211 may be a Broadcast Control Channel (BCCH). The terminal 230 includes a transceiver 232 that is configured to receive the CCH 211, and is further operative to communicate over other channels using frequency hopping and/or direct sequence spreading as specified in, for example, the GSM and/or CDMA specifications. The transceiver 232 is also configured to use substantially the same protocol as it uses to communicate with the licensed-use wireless communications system in a frequency band used by an unlicensed-use access point 220, for example, the unlicensed-use ISM band. In the exemplary embodiments described below, the CCH may be used to establish and/or control communications between the terminal 230 and the unlicensed-use access point 220 using, for example, information about the unlicensed-use access point 220 conveyed via the terminal 230 and/or via a network 240 coupling the base station 210 to the unlicensed-use access point 220.

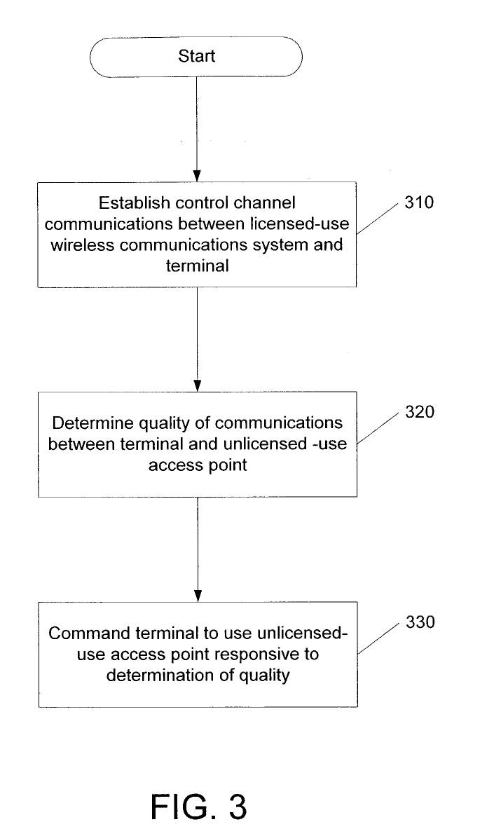

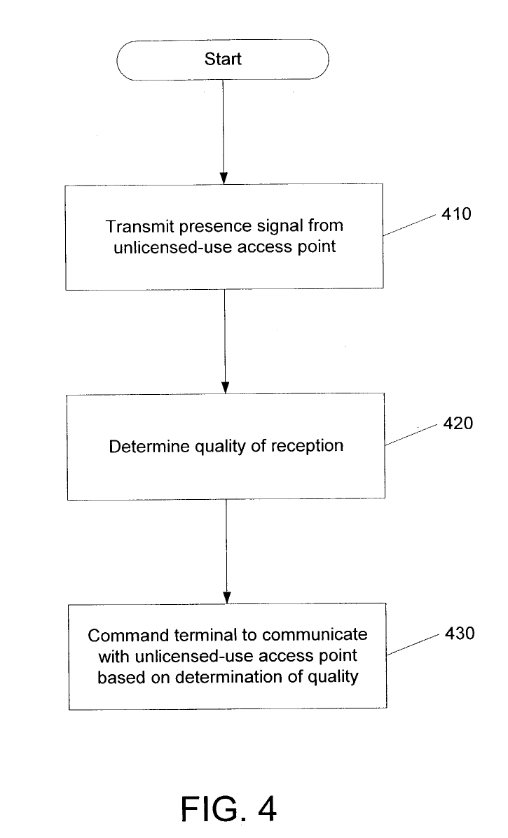

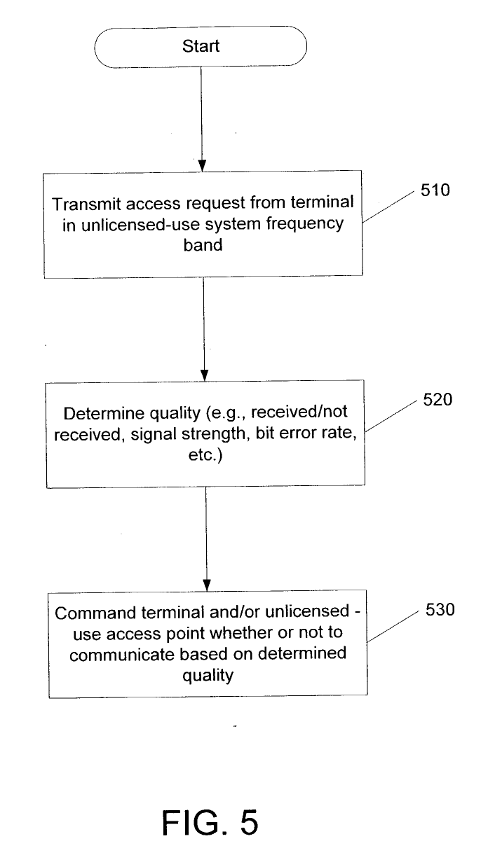

For example, as shown in FIG. 3, control channel communications may be established between the licensed-use wireless communications system and the terminal (Block 310). Quality of communications between the terminal and an unlicensed-use access point is then determined using, for example, one or more of the techniques described below with reference to FIGS. 4 and 5 (Block 320). The licensed-use wireless communications system may then command the terminal to use the unlicensed-use access point responsive to the determination of quality (Block 330).

In some embodiments illustrated in FIG. 4, quality may be determined by detection of a “presence” signal transmitted by the unlicensed-use access point. In particular, the unlicensed-use access point may continuously or intermittently transmit a presence signal, e.g., a frequency-hopped and/or direct-sequence spread signal conforming to the requirements of the unlicensed-use band (Block 410). Quality of reception of the presence signal at the terminal may then be determined using, for example, signal strength and/or other quality measurements, such as bit error rate (Block 420). The licensed-use wireless communications system may then command the terminal to communicate (or not communicate) with the unlicensed-use access point based on the determination of quality (Block 430), a measure of which is relayed to the system by the terminal.

FIG. 5 illustrates exemplary operations that may be used in lieu of, or in combination with, the operations of FIG. 4. A terminal may transmit an access grant request, e.g., a random access channel (RACH) message, on an unlicensed-use band frequency (Block 510). Quality of reception, e.g., whether the message was received and, if so, with what strength and/or other quality, is then determined (Block 520). A licensed-use wireless communications system in communication with the terminal may then command the terminal and/or the unlicensed-use access point to establish communications on an unlicensed-use band based on the determination of quality (Block 530).

Alternatively, and/or in combination with the operations of FIGS. 4 and/or 5, a terminal may transmit an access grant request on a licensed-use band frequency. Then, based on the quality of reception of an unlicensed-use access point presence signal by the terminal (a measure of which may be transmitted to the system by the terminal), the system may instruct the terminal and/or the unlicensed-use access point to initiate communications over the unlicensed-use band associated with the access point presence signal. It will be understood that, instead of the system making a decision regarding the terminal's ability to communicate with the unlicensed-use access point, the terminal itself can be configured to make such a decision and then inform the system. The system then may make a final determination (based on measures that may be related to it by the terminal) and inform the terminal and/or the relevant unlicensed-use access point.

Unlicensed-use networks may be configured as stand-alone networks. The GSM protocol may be used to provide communications and the control channels of GSM that currently do not hop may be configured/redefined to frequency hop. Besides GSM, CDMA protocols, particularly, W-CDMA protocols, may be used to provide communications over an unlicensed-use band with relatively insubstantial modifications to the protocol.

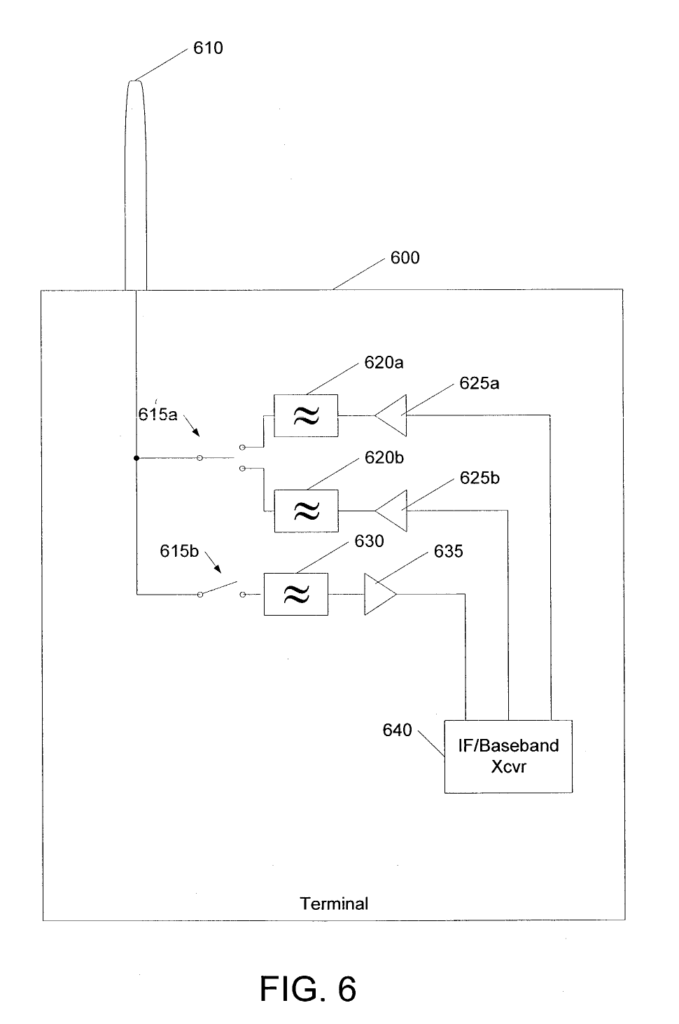

FIG. 6 illustrates a wireless terminal according to some embodiments of the present invention, in particular, a terminal 600 configured to communicate with a licensed-use wireless communications system using the frequencies thereof, and with unlicensed-use infrastructure (access points) using the frequencies thereof. The wireless terminal 600 includes an IF/baseband transceiver 640 (which may include analog-to-digital (A/D) and digital-to-analog (D/A) conversion, frequency synthesis, demodulation, modulation and other circuitry) that is fed by a low noise amplifier (LNA) 635 and receive filter 630, which are configured to be coupled to an antenna 610 by a switch 615b. The IF/baseband transceiver 640 also feeds the antenna 610 via first and second power amplifiers (PA) 625a, 625b and associated transmit filters 620a, 620b that are configured for communications over the licensed-use frequencies and the unlicensed-use frequencies, respectively, as selected by switch 615a. In this manner, IF and baseband circuitry, e.g., the IF/baseband transceiver 640, may be commonly used for communications with licensed-use and unlicensed-use systems. It will be appreciated that the dual PA configuration illustrated in FIG. 6 may be replaced with a single, broadband PA configuration. In addition, even though a single broad-band LNA 635 and filter 630 are illustrated, it will be understood that separate combinations of LNAs and/or filters may be used to separately provide front-end amplification and/or filtering for the licensed-use and unlicensed-use bands. It will also be understood that switch configurations 615a and 615b may be replaced by a frequency duplexer filter configuration, for example, in CDMA terminals.

In the drawings and foregoing description thereof, there have been disclosed exemplary embodiments of the invention. Terms employed in the description are used in a generic and descriptive sense and not for purposes of limitation, the scope of the invention being set forth in the following claims.

That which is claimed is:

1. A wireless communications method, comprising:
establishing control channel communications between a terminal and a first wireless communications system that supports a protocol in a licensed-use frequency band; and
communicating between the terminal and a second wireless communications system using a corresponding type of protocol in an unlicensed-use frequency band responsive to the control channel communications.

2. A method according to claim 1, wherein the first and second wireless communications systems employ direct-sequence spreading and/or frequency hopping.

3. A method according to claim 1, wherein the first wireless communications system comprises a GSM system and wherein the control channel comprises a Broadcast Control Channel (BCCH).

4. A method according to claim 1, wherein the first wireless communications system comprises a CDMA system.

5. A method according to claim 1, further comprising commanding the terminal over the control channel to utilize the second wireless communications system.

6. A method according to claim 5, further comprising:
determining quality of communications between the second wireless communications system and the terminal; and
wherein commanding the terminal over the control channel to utilize the second wireless communications system comprises commanding the terminal to utilize the second wireless communications system responsive to the determining of quality.

7. A method according to claim 6, wherein determining quality of communications between the second wireless communications system and the terminal comprises detecting a presence signal transmitted by the second wireless communications system.

8. A method according to claim 7, wherein detecting a presence signal comprises:
determining a signal pattern for the presence signal; and
detecting the presence signal based on the determined signal pattern.

9. A method according to claim 8, wherein determining a signal pattern comprises determining a frequency hop pattern.

10. A method according to claim 8, wherein determining a signal pattern comprises:
determining a time of day (TOD); and
determining the signal pattern based on the determined TOD.

11. A method according to claim 6:
wherein determining quality of communications between the second wireless communications system and the terminal comprises:
transmitting an access request message from the terminal;
receiving the access request message at the second wireless communications system; and
determining quality of communications between the terminal and the second wireless communications system from the received access request message;
wherein commanding the terminal over the control channel to utilize the second wireless communications system responsive to the determining of quality is preceded by communicating an indication of quality from the second wireless communications system to the first wireless communications system; and
wherein commanding the terminal over the control channel to utilize the second wireless communications system responsive to the determination of quality comprises commanding the terminal over the control channel to utilize a traffic channel of the second wireless communications system responsive to the communicated indication of quality.

12. A method according to claim 5, wherein commanding the terminal over the control channel to utilize the second wireless communications system comprises communicating information for providing multiple access discrimination for communications between the terminal and the second wireless communications system.

13. A method according to claim 1, comprising constraining the terminal to preferentially use the second wireless communications system for a type of communications.

14. A method according to claim 1, further comprising interleaving communications of the terminal between the first wireless communications system and the second wireless communications system.

15. A wireless communications method, comprising:
establishing and/or controlling communications of a wireless terminal with an unlicensed-use access point using a control channel of a licensed-use wireless communications system.

16. A method according to claim 15, wherein establishing and/or controlling communications of a wireless terminal with an unlicensed-use access point using a control channel of a licensed-use wireless communications system comprises establishing and/or controlling communications of a wireless terminal with an unlicensed-use access point using a Broadcast Control Channel (BCCH) of a GSM wireless communications system.

17. A method according to claim 15, wherein establishing and/or controlling communications of a wireless terminal with an unlicensed-use access point using a control channel of a licensed-use wireless communications system comprises establishing and/or controlling communications of a wireless terminal with an unlicensed-use access point using a control channel of a CDMA wireless communications system.

18. A method according to claim 16, further comprising communicating between the terminal and the unlicensed-use access point using substantially the same protocol supported by the licensed-use wireless communications system.

19. A method according to claim 18, wherein the licensed-use wireless communications system comprises a GSM system, and wherein communicating between the terminal and the unlicensed-use frequency access point using substantially the same protocol comprises using a frequency-hopping protocol.

20. A method according to claim 15, wherein establishing and/or controlling communications of a wireless terminal with an unlicensed-use access point using a control channel of a licensed-use wireless communications system comprises establishing and/or controlling communications of the wireless terminal with the unlicensed-use access point using the control channel responsive to quality of communications between the terminal and the unlicensed-use access point.

21. A method according to claim 20, further comprising detecting at the terminal a presence signal transmitted by the unlicensed-use access point, and wherein establishing and/or controlling communications of the wireless terminal with the unlicensed-use access point using the control channel responsive to quality of communications between the terminal and the unlicensed-use access point comprises establishing and/or controlling communications of the wireless terminal with the unlicensed-use access point responsive to detection of the presence signal.

22. A method according to claim 21, further comprising:
determining a signal pattern for the presence signal; and
detecting the presence signal based on the determined signal pattern.

23. A method according to claim 22, wherein determining a signal pattern comprises determining a frequency hop pattern.

24. A method according to claim 22, wherein determining a signal pattern comprises:
determining a time of day (TOD); and
determining the signal pattern based on the determined TOD.

25. A method according to claim 20, further comprising transmitting an access request message from the terminal, and wherein establishing and/or controlling communications of the wireless terminal with the unlicensed-use access point using the control channel responsive to quality of communications between the terminal and the unlicensed-use access point comprises establishing and/or controlling communications of the wireless terminal with the unlicensed-use access point using the control channel responsive to reception of the access request at the unlicensed-use access point.

26. A method according to claim 15, wherein establishing and/or controlling communications of a wireless terminal with an unlicensed-use access point using a control channel of a licensed-use wireless communications system comprises transmitting over the control channel information for multiple access discrimination for communications between the terminal and the unlicensed-use access point.

27. A method according to claim 15, further comprising constraining the terminal to preferentially use the unlicensed-use wireless communications system for a type of communications.

28. A method according to claim 15, further comprising interleaving communications of the terminal between the unlicensed use wireless communications system and the licensed-use wireless communications system.

29. A wireless communications system, comprising:
at least one of a licensed-use wireless communications system and an unlicensed-use wireless communications system; and
means for establishing and/or controlling communications of a wireless terminal with an unlicensed-use access point using a control channel of the licensed-use wireless communications system.

30. A system according to claim 29, wherein the means for establishing and/or controlling communications of a wireless terminal with an unlicensed-use access point using a control channel of a licensed-use wireless communications system comprises means for establishing and/or controlling communications of a wireless terminal with an unlicensed-use access point using a Broadcast Control Channel (BCCH) of a GSM wireless communications system.

31. A system according to claim 29, wherein the means for establishing and/or controlling communications of a wireless terminal with an unlicensed-use access point using a control channel of a licensed-use wireless communications system comprises means for establishing and/or controlling communications of a wireless terminal with an unlicensed-use access point using a control channel of a CDMA wireless communications system.

32. A system according to claim 29, further comprising means for communicating between the terminal and the unlicensed-use access point using substantially the same protocol supported by the licensed-use wireless communications system.

33. A system according to claim 32, wherein the licensed-use wireless communications system comprises a GSM system, and wherein the means for communicating between the terminal and the unlicensed-use access point using substantially the same protocol supported by the licensed-use wireless communications system comprises means for using a frequency-hopping protocol.

34. A system according to claim 29, wherein the means for establishing and/or controlling communications of a wireless terminal with an unlicensed-use access point using a control channel of a licensed-use wireless communications system comprises means for establishing and/or controlling communications of the wireless terminal with the unlicensed-use access point using the control channel responsive to quality of communications between the terminal and the unlicensed-use access point.

35. A system according to claim 34, further comprising means for detecting at the terminal a presence signal transmitted by the unlicensed-use access point, and wherein the means for establishing and/or controlling communications of the wireless terminal with the unlicensed-use access point using the control channel responsive to quality of communications between the terminal and the unlicensed-use access point comprises means for establishing and/or controlling communications of the wireless terminal with the unlicensed-use access point responsive to detection of the presence signal.

36. A system according to claim 35, further comprising:
means for determining a signal pattern for the presence signal; and
means for detecting the presence signal based on the determined signal pattern.

37. A system according to claim 36, wherein the means for determining a signal pattern comprises means for determining a frequency hop pattern.

38. A system according to claim 36, wherein the means for determining a signal pattern comprises:
means for determining a time of day (TOD); and
means for determining the signal pattern based on the determined TOD.

39. A system according to claim 34, further comprising means for transmitting an access request message from the terminal, and wherein the means for establishing and/or controlling communications of the wireless terminal with the unlicensed-use access point using the control channel responsive to quality of communications between the terminal and the unlicensed-use access point comprises means for establishing and/or controlling communications of the wireless terminal with the unlicensed-use access point using the control channel responsive to reception of the access request at the unlicensed-use access point.

40. A system according to claim 29, wherein the means for establishing and/or controlling communications of a wireless terminal with an unlicensed-use access point using a control channel of a licensed-use wireless communications system comprises means for transmitting over the control channel information for multiple access discrimination for communications between the terminal and the unlicensed-use access point.

41. A system according to claim 29, further comprising means for constraining the terminal to preferentially use the unlicensed-use wireless communications system for certain classes of communications.

42. A system according to claim 29, further comprising means for interleaving communications of the terminal between the unlicensed use wireless communications system and the licensed-use wireless communications system.

43. A wireless communications system, comprising:
a base station operative to establish and/or control communications of a wireless terminal with an unlicensed-use access point using a control channel defined in a licensed-use allocated to the wireless communications system.

44. A system according to claim 43, wherein the wireless communications system comprises a GSM wireless communications system, and wherein the base station is operative to establish and/or control communications of the wireless terminal with an unlicensed-use access point using a Broadcast Control Channel (BCCH).

45. A system according to claim 43, wherein the wireless communications system comprises a CDMA wireless communications system, and wherein the base station is operative to establish and/or control communications of the wireless terminal with an unlicensed-use access point using a control channel of the CDMA wireless communications system.

46. A wireless terminal comprising:
a transceiver operative to communicate over a control channel with a base station of a first wireless communications system that supports a spread-spectrum protocol in a first frequency band subject to a license and to communicate, responsive to a command received over the control channel, with a second wireless communications system that uses a corresponding type of spread-spectrum protocol in a second frequency band in an unlicensed manner.

47. A terminal according to claim 46, wherein the first and second wireless communications systems employ direct-sequence spreading and/or frequency hopping.

48. A terminal according to claim 46, wherein the first wireless communications system comprises a GSM system and wherein the control channel comprises a Broadcast Control Channel (BCCH).

49. A terminal according to claim 46, wherein the first wireless communications system comprises a CDMA system.

50. A terminal according to claim 46, wherein the transceiver is operative to detect a presence signal transmitted by the second wireless communications system.

51. A terminal according to claim 46, wherein the transceiver is operative to transmitting an access request message to the second wireless communications system.

52. A wireless terminal, comprising:
a transceiver operative to communicate with an unlicensed-use access point and a licensed-use wireless communications system using substantially the same protocol.

53. A terminal according to claim 52, wherein the unlicensed-use access point and a licensed-use wireless communications system employ direct-sequence spreading or frequency hopping.

54. A terminal according to claim 52, wherein the licensed-use wireless communications system comprises a GSM system.

55. A terminal according to claim 52, wherein the licensed-use wireless communications system comprises a CDMA system.

56. A terminal according to claim 52, wherein the transceiver is operative to detect a presence signal transmitted by the unlicensed-use access point.
